(19) United States
(12) Patent Application Publication
(10) Pub. No.: US 2021/0109615 A1
(43) Pub. Date: Apr. 15, 2021

(54) RESISTIVE PRESSURE SENSOR DEVICE SYSTEM

(71) Applicant: RET Equipment Inc., Pleasanton, CA (US)

(72) Inventors: Frank Hu, Cupertino, CA (US); Yu Qiu, Los Angeles, CA (US)

(21) Appl. No.: 16/984,459

(22) Filed: Aug. 4, 2020

Related U.S. Application Data
(63) Continuation-in-part of application No. PCT/US2020/032933, filed on May 14, 2020.
Application No. PCT/US2020/032933 is a continuation-in-part of application No. 16/712,756, filed on Dec. 12, 2019, now abandoned.
(60) Provisional application No. 62/914,827, filed on Oct. 14, 2019.

(51) Int. Cl. G06F 3/045; G06F 3/041

(52) U.S. Cl. CPC G06F 3/045; G06F 3/0414; G06F 2203/04102; G06F 2203/04107; G06F 3/04166

(57) ABSTRACT

A system for measuring a change in the force applied along an orthogonal z-axis at an x-y coordinate in an x-y coordinate plane of a pressure receiving surface of a resistive pressure sensing device. The system is capable of detecting small discrete pressure changes at the x-y coordinate location through measurement of a change in a conducted electrical signal caused by a discrete change in the resistance between two electrode layers of the resistive pressure sensing device, at least one of which is patterned to have a conductive path made up of discrete conductive lines separated by insulating gaps.

This application is a continuation-in-part of and claims the benefit of priority to International PCT patent application PCT/US20/032933 filed on May 14, 2020, which is a continuation-in-part of and claims the benefit of U.S. patent application Ser. No. 16/712,756 that was filed on Dec. 12, 2019, which claims the benefit of U.S. provisional patent application 62/914,827 filed on Oct. 14, 2019, the full contents of each of which are hereby incorporated by reference.

### TECHNICAL FIELD

The present invention is in the field of pressure sensors.

### BACKGROUND

A touch panel is a type of input device that allows a user to input information through physical contact with a panel device. The touch panel is generally used as the input device for various kinds of products such as appliances, televisions, notebook computers and monitors as well as portable electronic devices such as electronic notebooks, electronic books (e-books), PMPs (Portable Multimedia Players), GPS navigation units, UMPCs (Ultra Mobile PCs), mobile phones, smart phones, Smart watches, tablet PCs (tablet Personal Computers), watch phones, and mobile communication terminals.

Recent user interface environments have applications that may require accurate information on the amount of pressure applied to a touch screen panel, and the present invention is intended to address this need.

Another problem found in many touch panel technologies is that they lack the ability to track multiple points of contact simultaneously. The most commonly used technology for a multitouch system is projected capacitive method. However, the projected capacitive method has some significant limitations. For example, it is unable to detect touch input from non-conductive objects such as a plastic stylus and can only detect touch location in two dimensions (i.e. touch points in an x-y plane).

Recently, some touch panel technologies have also attempted to add the function of sensing the depth of force as this could enable sensing a touch location in three dimensions (i.e. an x-y-z volume). One three-dimensional approach has been to incorporate a resistive force sensing mechanism. However, most resistive force sensors suffer from poor sensitivity of detecting a light force touch. In order to overcome these limitations, hybrid systems incorporating resistive force sensing devices into capacitive touch panels have been proposed. However, these systems are limited because they cannot individually measure multiple forces applied at different locations.

An alternative means of providing three-dimensional touch location is by adding an additional substrate having a resistive layer above a conventional capacitive sensor. This system however requires additional controller circuitry (and hence cost) that can stimulate and measure the response of the two sensor layers at multiple frequencies. The increased complexity of the circuit design and also reduces the accuracy of the sensor device.

The present pressure sensor invention addresses these problems by being capable of being incorporated into and used with conventional touch panel electronic systems to more precisely measure the force while also being capable of configuration to simultaneously identify multiple touch locations. In an exemplary preferred embodiment, the touch panel pressure sensor is optically transparent such that it can be applied to visual touch screen devices.

### SUMMARY OF THE INVENTION

In the present invention, there is provided an improved resistive pressure sensor device capable of detecting very small discrete pressure changes through measuring a discrete resistance involving two electrode layers, at least one of which is patterned to comprise a plurality of conductive paths that are made up of discrete conductive lines separated by insulating gaps. Discrete changes in resistance may be detected from discrete changes occurring in the contact area between the two electrode layers due to the use of discrete conductive lines in the electrode layers. The resistive pressure sensor device of the present invention is also capable of being configured for use in an electronic system with conventional multi-touch detection hardware and software to detect and process multiple touches and applied pressures that occur at substantially the same time at distinct locations on the touch surface of the pressure sensor. In a preferred exemplary embodiment, the resistive pressure sensor device is optically transparent with optically transparent substrates and electrode layers so as to be combined with a visual display device. However, in other embodiments the resistive pressure sensor device of the present invention can be incorporated into other systems or devices where transparency is not required.

In a preferred optically transparent embodiment, the optically transparent electrode layers comprise a conductive polymer composite formed with conductive nanoparticles that help ensure flexibility, stability and optical transparency. The pressure sensor of the present invention is optically transparent and is thus well suited to being applied to a touch display panel.

In a first optically transparent embodiment, the optically transparent pressure sensor comprises an optically transparent pressure panel that is joined to an optically transparent support panel. The pressure panel comprises an optically transparent pressure substrate that is coated on a pressure receiving surface with an optically transparent protective coating and has an opposing support panel facing surface that has an optically transparent pressure panel electrode layer. The pressure substrate, protective coating, and pressure panel electrode layer are all substantially transparent to light in the optical wavelengths. The support panel, which is adjacent to and substantially parallel to the pressure panel, comprises an optically transparent support substrate that has a pressure panel facing surface having an optically transparent support panel electrode layer, optically transparent spacers acrylic based polymer, silicone), and an optically transparent attachment member. The support substrate, support panel electrode layer, spacers, and attachment member are all substantially transparent to light in the optical wavelengths. The attachment member is along the outer edge of the support panel and is used to join together the pressure and support panels to form an optically transparent insulating space located between the support panel facing surface of the pressure substrate and the pressure panel facing surface of the support substrate. The insulating space may contain an optically transparent insulator.

The pressure substrate and support substrate may be comprised of a material such as PET (polyethylene terephthalate) or glass which is substantially transparent to light in the optical wavelengths. The pressure panel electrode layer and support panel electrode layer achieve substantial transparency in the optical wavelengths by being applied in very thin coatings of less than 200 nm and/or being an inherently transparent material (e.g. ITO (indium tin oxide)).

In a second embodiment, the optically transparent pressure sensor comprises generally an optically transparent pressure panel and an optically transparent support panel as described for the first embodiment. However, the pressure panel further comprises an optically transparent electrode substrate that is located on the support panel facing surface of the pressure substrate and in which the pressure panel electrode layer is partially embedded. The electrode substrate is comprised of an optically transparent material such as an acrylic based polymer.

As used herein the term “optically transparent” as applied to any object means that light may pass through the object to be perceived by a human eye. Thus, light in the visible portion of the spectrum may pass through the optically transparent pressure sensor of the present invention to be perceived by a human eye.

In a third embodiment the resistive pressure sensing device is part of a multi-touch x-y-z positional pressure sensor system that comprises the resistive pressure sensing device of either the first or second embodiments and an electronic sensor controller with a connection to a host system. The electronic controller detects a location on a two-dimensional plane (e.g. an x-y plane of a touch panel surface) where a force is being applied and simultaneously measure the amount of force being applied at the location which can be calculated in some embodiments to be representative of a “depth” in a third dimension (e.g. a z-axis of a touch panel).

### BRIEF DESCRIPTION OF THE DRAWINGS

FIG. 1 shows a cross sectional view of a first exemplary embodiment of the resistive pressure sensor device of the present invention in an uncompressed state.

FIG. 2 shows a cross sectional view of a first exemplary embodiment of the resistive pressure sensor device of the present invention in a compressed state.

FIG. 3 shows a front perspective view of the top surface of the optically transparent pressure substrate for a first exemplary embodiment of the resistive pressure sensor device of the present invention.

FIG. 4 shows a rear perspective view of the support panel facing surface of the optically transparent pressure substrate of FIG. 3.

FIG. 5 shows a front perspective view of the pressure panel facing surface of the optically transparent support substrate for a first exemplary embodiment of the resistive pressure sensor device of the present invention.

FIG. 6 shows a front perspective view of a conductive support layer path from the optically transparent support panel electrode layer on the pressure panel facing surface of the support substrate.

FIG. 7 shows a front side view of a conductive support layer path from the optically transparent support panel electrode layer on the pressure panel facing surface of the support substrate.

FIG. 8 shows a front perspective view of an optically transparent spacer from the pressure panel facing surface of the support substrate.

FIG. 9 shows a front perspective view of an optically transparent attachment member of the support panel in relation to its position along the outer edge of the pressure panel facing surface of the support substrate.

FIG. 10 shows a front perspective view of the attachment member in position along the outer edge of the pressure panel facing surface of the support substrate.

FIG. 11 shows a front perspective view of the optically transparent pressure panel above the optically transparent support panel with the optically transparent insulating space occupied by an optically transparent insulator prior to the pressure panel being joined to the upper edge of the attachment member.

FIG. 12 shows a front perspective view of the assembled resistive pressure sensor device once the pressure panel and support panel are joined together and a power source is connected.

FIG. 13 is a front perspective view of the conductive support layer paths that make up the optically transparent support panel electrode layer.

FIG. 14 is a top side view of a first exemplary line pattern for a conductive support layer path of the support panel electrode layer.

FIG. 15 is a top side view of a second exemplary line pattern for a conductive support layer path of the support panel electrode layer.

FIG. 16 is a top side view of a third exemplary line pattern for a conductive support layer path of the support panel electrode layer.

FIG. 17 is a top side view of a fourth exemplary line pattern for a conductive support layer path of the support panel electrode layer.

FIG. 18 is a top side view showing the optically transparent pressure panel electrode layer overlaid on the optically transparent support substrate and showing the optically transparent support panel electrode layer and optically transparent spacers.

FIG. 19 is a flowchart of the steps for the process of making a first embodiment of the resistive pressure sensor device of the present invention.

FIG. 20 is a flowchart of the steps for the process of making a second embodiment of the resistive pressure sensor device of the present invention.

FIG. 21 is a schematic of the different layered components of a first embodiment of the resistive pressure sensor device of the present invention.

FIG. 22 is a schematic of the different layered components of a second embodiment of the resistive pressure sensor device of the present invention.

FIG. 23 is a schematic of the pressure panel electrode layer composition for a first embodiment of the resistive pressure sensor device of the present invention.

FIG. 24 is a schematic of the optically transparent pressure panel electrode layer composition for a second embodiment of the resistive pressure sensor device of the present invention.

FIG. 25 shows a cross sectional view of a second exemplary embodiment of the resistive pressure sensor device of the present invention in an uncompressed state.

FIG. 26 shows a cross sectional view of a second exemplary embodiment of the resistive pressure sensor device of the present invention in a compressed state.

FIG. 27 shows for a reduction to practice of the resistive pressure sensor device of the present invention test data of the measured transmittance as a function of light wavelength from 300-800 nm for the device and that of a glass slide.

FIG. 28 shows for a reduction to practice of the resistive pressure sensor device of the present invention test data of the pressure versus resistance curve of a representative pixel on the device.

FIG. 29 shows for a reduction to practice of the resistive pressure sensor device of the present invention test data of the pressing force versus resistance curve of a representative pixel on the device.

FIG. 30 shows a top side view of the X-axis conductive pressure layer paths and Y-axis conductive support layer paths of the resistive pressure sensor device invention as configured for an x-y-z axis implementation.

FIG. 31 shows an electronic schematic of the resistive pressure sensor device invention as configured for an x-y-z axis implementation.

FIG. 32 shows a block diagram of an electronic system with the resistive pressure sensor device invention configured for an x-y-z axis implementation.

FIG. 33 shows a block diagram of an electronic system with the resistive pressure sensor device invention configured for an x-y-z axis implementation.

### DETAILED DESCRIPTION OF THE INVENTION

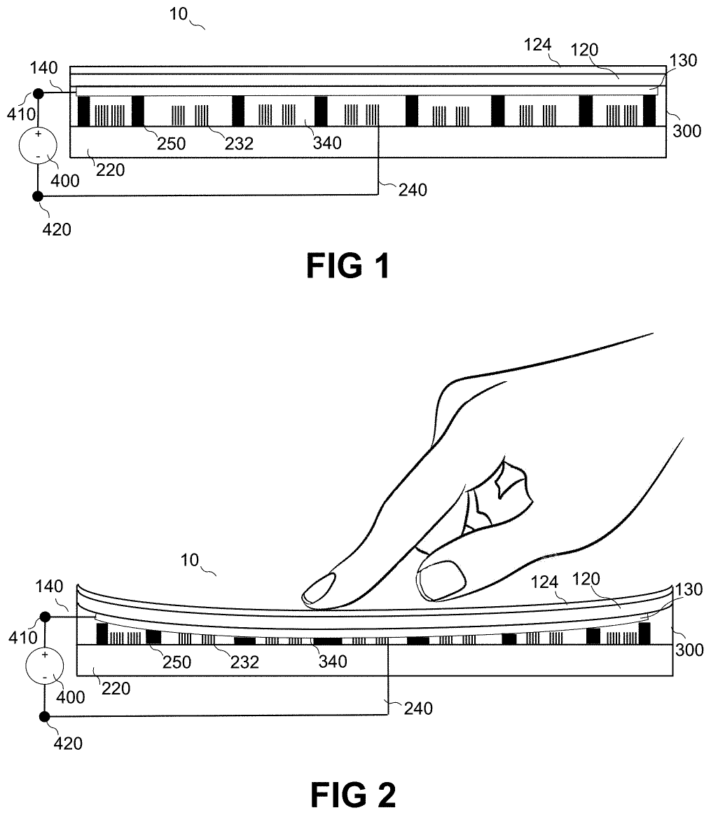

FIGS. 1-2 show a cross-sectional view of resistive pressure sensor device 10 according to a first preferred embodiment in an uncompressed state (FIG. 1) and a compressed state (FIG. 2) with a pressure force applied to its pressure receiving surface. Referring to FIG. 12, the resistive pressure sensor device 10 is comprised generally of an optically transparent pressure panel 100 that is joined to an optically transparent support panel 200.

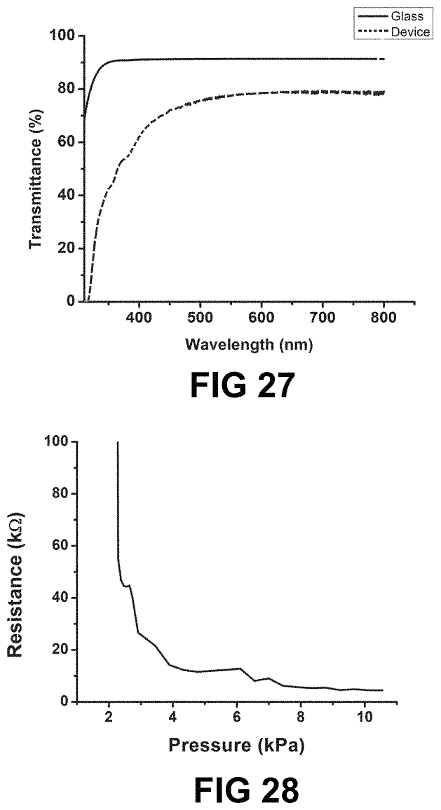

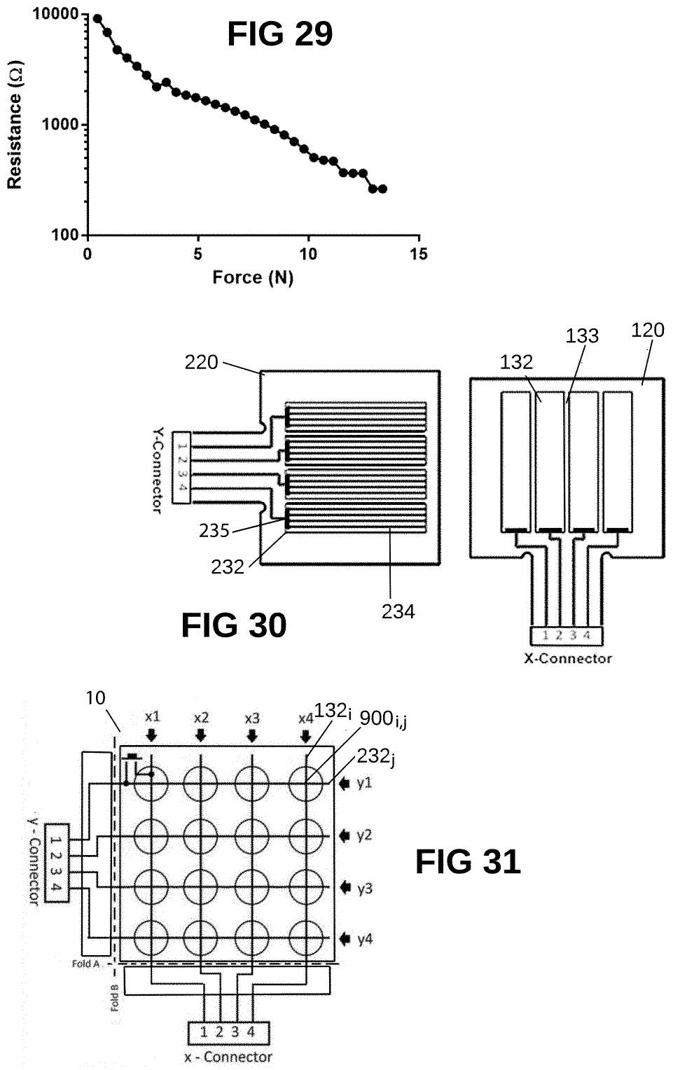

Referring to FIG. 27 data from measurements of the transmittance spectrum of a constructed prototype of the present invention and that of a glass slide in the visible light wavelength region is shown. The transmittance of the prototype of the present invention is as high as 80% across the visible light region. Such high optical transparency is a useful feature for integration with optical devices such as displays.

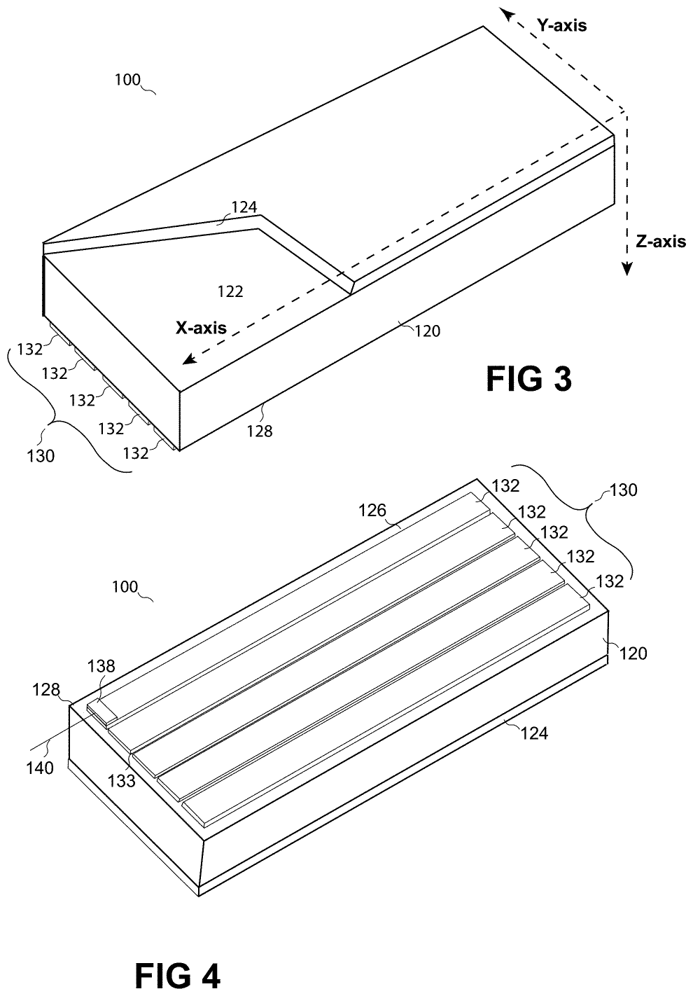

Referring to FIGS. 3-4 the optically transparent pressure panel 100 comprises an optically transparent pressure substrate 120 having a pressure receiving surface 122 and an opposing support panel facing surface 126. Pressure substrate 120 may, by way of example and not limitation be comprised of glass, polyethylene terephthalate (PET), poly(ethylene 2,6-naphthalate) (PEN), polycarbonate (PC), poly(methyl methacrylate) (PMMA), polystyrene (PS), polyethersulfone (PES), or polynorbornene (PNB). The material of pressure substrate 120 is formulated so as to have sufficient elasticity to permit it to bend from a resting position under the force levels anticipated to be applied during use to pressure receiving surface 122 (e.g. the pressure of a human finger pressing down) and then return to its original resting position once the force is no longer being applied to pressure receiving surface 122. In a preferred embodiment pressure receiving surface 122 may be coated with an optically transparent coating to form a protective coating 124. The optically transparent protective coating 124 applied may comprises a transparent crosslinked polymer resin. The resin can be polymerized from a mixture of mono and multifunctional acrylic monomers and oligomers. Protective coating 124 may be formed of a nanocomposite comprising a high loading of inorganic nanoparticles and a cured polymer resin matrix, a multilayer coating comprising alternating layers of nanometer thick inorganic deposit (such as silicon oxide, silicon nitride, aluminum oxide) and polymer, or thin glass with high hardness. The application of the protective coating 124 can be slot die coating, gravure coating, Meyer rod coating, and spray coating followed by curing under heating or exposure to UV light. The multilayer stack coating and hard glass may be laminated onto pressure receiving surface 122 during the original manufacture of pressure substrate 124. Any material used for protective coating 124 should have an elasticity at least matching that of pressure substrate 120 so that protective coating 124 may bend (i.e. flex) with pressure substrate 120 when a pressure is applied and released.

In the first exemplary embodiment, the optically transparent pressure panel electrode layer 130 is applied to support panel facing surface 126 of pressure substrate 120. Pressure panel electrode layer 130 comprises a conductive material that when deposited on support panel facing surface 126 will have an elasticity at least matching that pressure substrate 120 so that it may bend with pressure substrate 120 when a pressure is applied. For example, pressure panel electrode layer 130 may comprise conductive materials such as indium-tin-oxide (ITO), indium-zinc-oxide (IZO), indium-tin-zinc-oxide (ITZO), poly(3,4-ethylenedioxythiophene) polystyrene sulfonate (PEDOT:PSS), carbon nanoparticles, carbon nanotubes, graphene, metal nanoparticles, metal nanowires (e.g. silver nanowire (AgNW)), metal nanogrid, metal mesh, conductive polymer nanoparticles, conductive polymer nanoporous network or the mixture thereof. Pressure panel electrode layer 130 can achieve high conductivity as a very thin film. The thickness of the pressure panel electrode layer 30 should be below 200 nm. In this way the transparency of pressure panel electrode layer 130 can be very high. The application of the pressure panel electrode layer 130 to support panel facing surface 126 may involve slot die coating, spray coating, or Meyer rod coating a very thin layer of the conductive material.

Referring to FIGS. 4 and 12 in a preferred embodiment optically transparent pressure panel electrode layer 130 comprises a plurality of substantially parallel and straight conductive pressure layer paths 132 separated by insulating gaps 133. The pattern of conductive pressure layer paths 132 and insulating gaps 133 are formed on pressure panel electrode layer 130 by laser ablation. At an end of each conductive pressure layer path 132 there is a conductive connector 138 (e.g. silver paste or solder) that forms an electrical connection between each conductive pressure layer path 132 and an electrical path 140 (e.g. a conductive wire or trace) to a first polarity terminal 410 of voltage source 400 (e.g. a direct current source with a voltage of less than ten volts). Note that for clarity of illustration only one of the conductive connectors 138 and electrical paths 140 are shown in illustration.

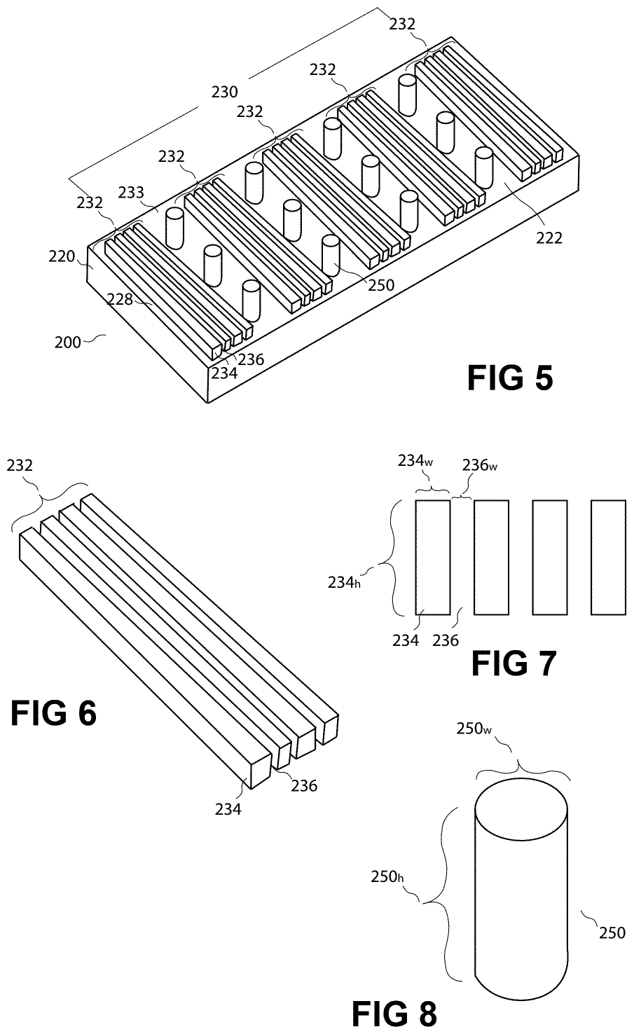

Referring to FIG. 5 optically transparent support panel electrode layer 230 is attached to pressure panel facing surface 224 of support substrate 220. Support substrate 220 may be comprised of, by way of example and not limitation, clear glass which should have an elasticity that is less than that of pressure panel 100 so that support panel 200 does not bend when a pressure force is applied to pressure panel 100: This facilitates the contact area between pressure panel electrode layer 130 and support panel electrode layer 230 varying as a function of the amount of pressure applied.

By way of example and not limitation, support substrate 220 may be comprised of glass which generally has a Young's modulus of around 7 GPa. The pressure substrate 120 may by way of example be a flexible plastic film such as PET, PEN, or PC. The Young's modulus of plastic films is smaller than glass (e.g. PET: 2-2.7 GPa), The pressure substrate 120 can also comprised of glass if it is thinner than the glass of the support substrate 220. In such an exemplary case the pressure substrate 120 and the support substrate 220 would share the same Young's modulus for glass, but the thickness of the pressure substrate 120 (e.g. 0.1-0.33 mm) would be much smaller than that of the support substrate 220 (1-2 mm) such that the amount of force required to bend the pressure substrate 120 would be far less than that for the support substrate 220. Both plastic films and glass with different thicknesses are readily available commercially.

Optically transparent support panel electrode layer 230 may comprise conductive materials such as indium-tin-oxide (ITO), indium-zinc-oxide (IZO), indium-tin-zinc-oxide (ITZO), poly(3,4-ethylenedioxythiophene) polystyrene sulfonate (PEDOT:PSS), carbon nanoparticles, carbon nanotubes, graphene, metal nanoparticles, metal nanowires (e.g. silver nanowire (AgNW)), metal nanogrid, metal mesh, conductive polymer nanoparticles, conductive polymer nanoporous network or the mixture thereof.

Referring to FIG. 5, in a preferred exemplary embodiment, optically transparent support panel electrode layer 230 comprises a plurality of adjacent conductive support layer paths 232 separated by insulating gaps 233. In the preferred embodiment conductive support layer paths 232 are oriented substantially perpendicular to the conductive pressure layer paths 132. However, the orientation of conductive pressure layer paths 132 and conductive support layer paths 232 are not limited in the present invention to being substantially perpendicular but may be varied depending upon the particular application. At an end of each conductive support layer path 232 there is a conductive connector 238 (e.g. silver paste or solder) that forms an electrical connection between each conductive support layer path 232 and an electrical path 240 (e.g. a conductive wire or trace) to a second polarity terminal 420 of voltage source 400. Note that for clarity of illustration in some figures only one of the conductive connectors 238 and/or electrical paths 240 may be shown in illustration.

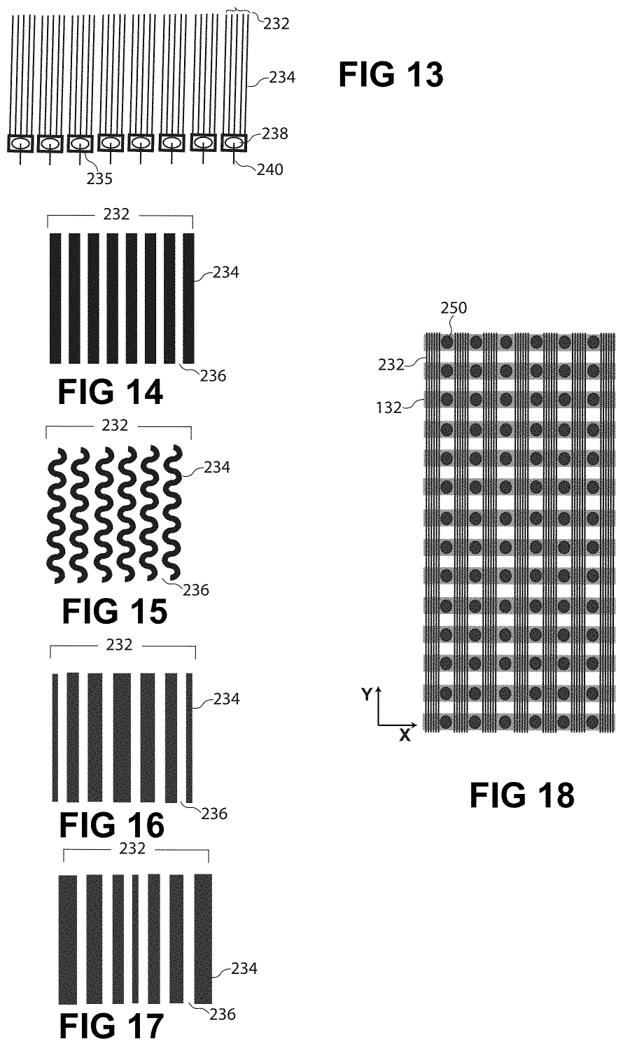

Referring to FIGS. 5-7 each optically transparent conductive support layer path 232 of support panel electrode layer 230 comprises one or more conductive lines 234, with each conductive line having a height 234h and width 234w. In a preferred exemplary embodiment, the conductive lines 234 are electrically joined together at a path connector end 235. Each line 234 is separated from any adjacent line 234 with an insulating gap 236, with each insulating gap having a width of 236w: Referring to FIGS. 13-17, the conductive lines 234 of a conductive support layer path 232 may be patterned, such as by way of example and not limitation, with each line 234 having the same width 234w (FIG. 14), or each line 234 being curved with the same width 234w (FIG. 15), or each line 234 being straight but having different widths (FIGS. 16-17). Lines 234 may also have a variable width 234w along their length. Insulating gaps 236 may also be patterned to have constant or variable widths 236w within a column 232.

It is contemplated that in an alternative embodiment it would be optically transparent conductive pressure layer paths 132 of pressure panel electrode layer 130 which would be comprised of conductive lines and insulating gaps electrically joined together at a path connector end, while the conductive support layer paths 232 of support panel electrode layer 230 would not have such conductive lines. Accordingly, there are embodiments where it is either the pressure panel electrode layer 130 or the support panel electrode layer 230, but not both, which has at least one conductive layer path with discrete conductive lines and insulating gaps electrically joined together at a path connector end. In other embodiments the pressure panel electrode layer 130 and the support panel electrode layer 230 both have at least one conductive layer path with discrete conductive lines and insulating gaps electrically joined together at a path connector end.

Referring to the embodiment of FIGS. 5-7 the pattern of conductive lines 234 of a conductive support layer path 232 for support panel electrode layer 230 will affect the surface contact area that occurs between pressure panel electrode layer 130 and support panel electrode layer 230 when a pressure is applied to the pressure receiving surface of touch substrate 120. Generally, the electrical resistance between two electrodes decreases as the area of contact between the electrode surfaces increases. By having the conductive lines 234 of conductive support layer paths 232 formed in a particular pattern the contact surface area, and thus resistance, between the pressure panel electrode layer 130 and support panel electrode layer 230 can be controlled to obtain discrete and sensitive resistance measurements for a broad range of pressures applied to the resistive pressure sensor device.

Referring to FIGS. 5 and 8 one or more optically transparent spacers 250 are attached to pressure panel facing surface 222 of support substrate 220. In a preferred exemplary embodiment, each spacer 250 may be in the shape of a pillar with a diameter 250w that is 30-100 μm (the threshold dimension for resolution by an unaided human eye) and a height 250h ranging from 50-100 μm. The spacers 250 may be formed of optically clear adhesive (OCA), optically clear resin, or clear photoresist. Spacers 250 keep the pressure panel electrode layer 130 and support panel electrode layer 230 from being in electrical contact when no pressure is applied to pressure substrate 120. The distance between two adjacent spacers 250 may be equal to or smaller than the distance between two adjacent pixels. The distance between two adjacent spacers 250 may also vary depending on the elasticity of pressure panel 100.

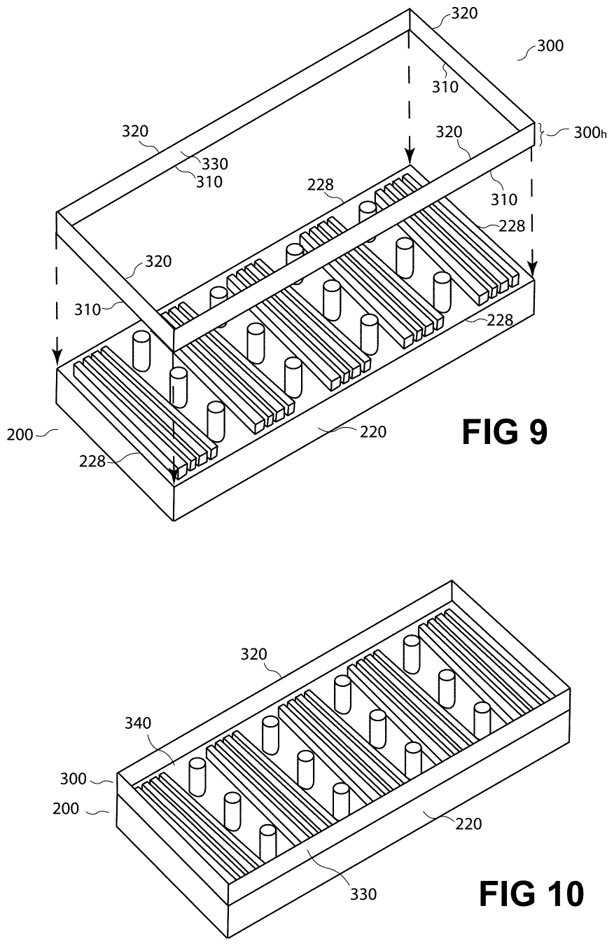

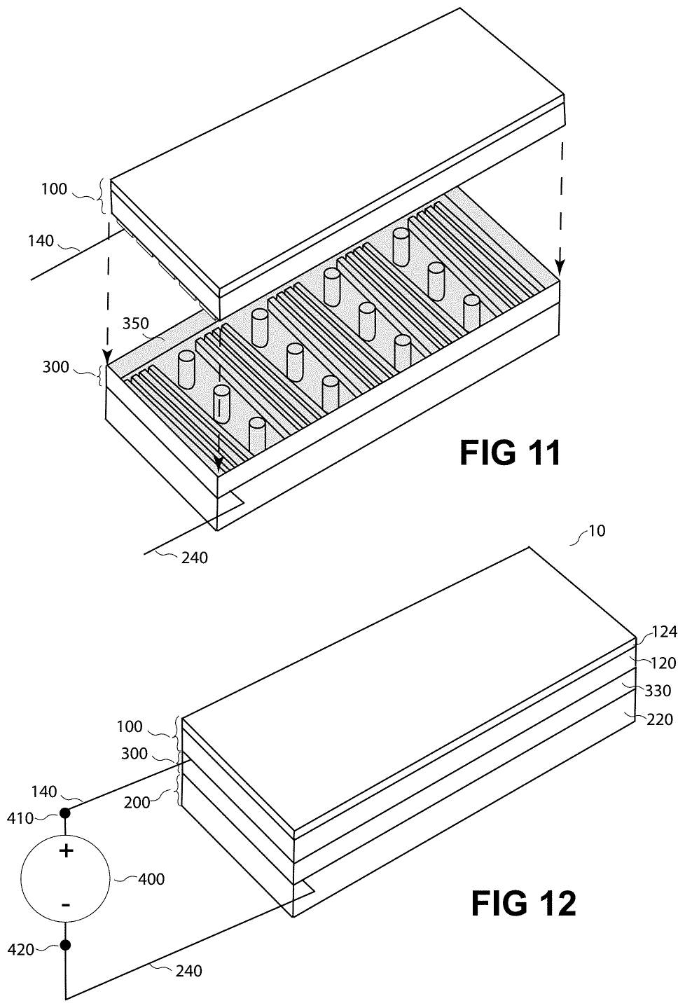

Referring to FIGS. 9-12 optically transparent pressure panel 100 and optically transparent support panel 200 are joined together through an optically transparent attachment member 300 that is located along the outer edge 228 of pressure panel facing surface 222 of support substrate 220. Attachment member 300 may be comprised of monomers that are first screen printed on support substrate 220, and which will be cured one pressure panel 100 is placed attachment member 300. Alternatively, attachment member 300 may be pre-made into an adhesive film which is cut and laminated between pressure panel 100 and support panel 200.

There is an optically transparent insulating space 340 that is located between the pressure substrate 120 support panel facing surface 126, the support substrate 220 pressure panel facing surface 226 and the attachment member 300. In preferred embodiments the attachment member 300 forms a continuous solid perimeter wall that traverses the entire length of outer edges 128 and 228 such that the insulating space 340 is closed. However, in other embodiments there may be one or more openings in the attachment member 300 such that the insulating space 340 is not entirely closed. It is contemplated that insulating space 340 would be occupied by an optically transparent insulator 350 which has electrical insulating properties such that when no force is applied to pressure sensor panel 100 (i.e. in a resting position) there will be no electrical current between pressure panel electrode layer 130 and support panel electrode layer 230. Insulator 350 may, by way of example and not limitation, be an insulating gas or gaseous mixture such as air, or may be a non-volatile liquid such as ethylene glycol, silicone oil, or mineral oil.

FIGS. 1 and 2 illustrate an exemplary pressure sensing event using resistive pressure sensor 10. With no pressure applied, i.e., while at rest, the pressure panel electrode layer 130 and support panel electrode layer 230 are not in contact and so there is an open circuit with no measurable current flow (i.e. extremely large resistance). When a pressure force is applied to the pressure receiving surface 122, as in FIG. 2, the pressure substrate 120 will bend (i.e. flex) towards the support substrate 220. At a certain minimum level of applied force this will cause a conductive pressure layer path 132 to make contact with a conductive line 234 of a conductive support layer path 232 closing the circuit and causing a measurable current to flow between the pressure and support panel electrode layers. When pressure is reduced or removed pressure substrate 120 will return to its unbent (i.e. unflexed) position restoring the insulating space between pressure electrode 130 and support electrode 230.

Referring to FIG. 28 it is shown that a difference in the degree of pressure (i.e. force) affects a difference in the area of surface contact between the pressure and support panel electrode layers: Any increase in pressure above the minimum level of applied pressure will cause an increase in the contact area between the conductive pressure layer paths 232 and discrete conductive lines 234 of conductive support layer paths 232 which will incrementally decrease the resistance of the circuit and increase the current flow.

More specifically, referring to FIG. 28, data from measurements of a prototype of the present invention with pressure applied to the pressure receiving surface up to 10 kPa is shown. Without any applied pressure, a closed circuit is not formed between the pressure and support panel electrode layers. At an applied force of approximately 2 kPa a closed circuit between the electrode layers was created that had a measured resistance of around 700 kΩ. As shown with increased applied force the measured resistance of the closed circuit between the electrode layers decreased with a measured resistance of around 4 kΩ when the applied force was increased to approximately 10 kPa.

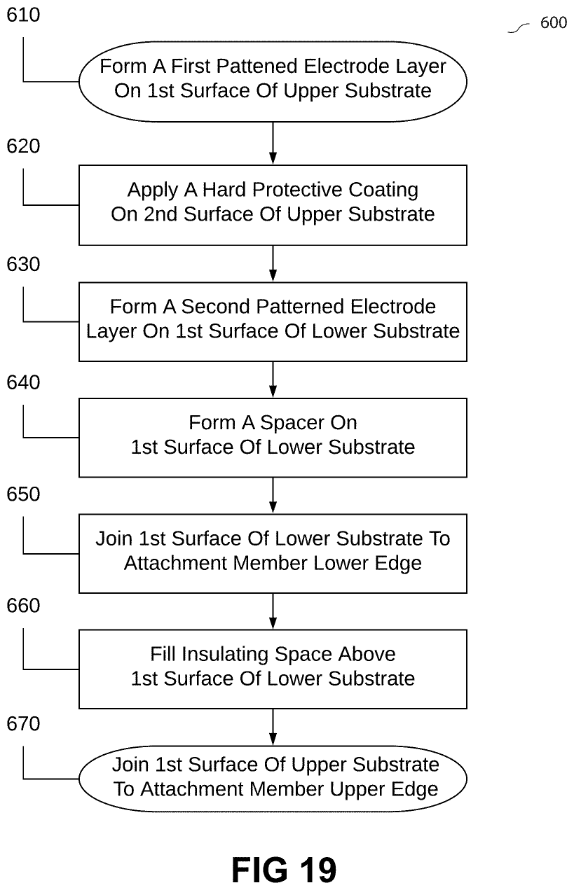

Referring to FIG. 19 the steps of the process 600 of fabricating a first preferred embodiment of the resistive pressure sensor 10 of the present invention are shown.

The fabrication process starts with step 610 of forming an optically transparent pressure panel electrode layer 130 from conductive material on support panel facing surface 126 of pressure substrate 120. In a preferred embodiment the pressure panel electrode layer is a pattern of straight rows of conductive pressure layer paths 132. The conductive material may comprise indium-tin-oxide (ITO), indium-zinc-oxide (IZO), indium-tin-zinc-oxide (ITZO), poly(3,4-ethylenedioxythiophene) polystyrene sulfonate (PEDOT:PSS), carbon nanoparticles, carbon nanotubes, graphene, metal nanoparticles, metal nanowires (e.g. silver nanowire (AgNW)), metal nanogrid, metal mesh, conductive polymer nanoparticles, conductive polymer nanoporous network or the mixture thereof. The conductive material can be applied onto support panel facing surface 126, by way of example and not limitation, via slot die coating, spray coating, or Meyer rod coating. The conductive material may then be patterned using laser ablation. The conductive material applied will attach itself to support panel facing surface 126 through intermolecular forces. Support panel facing surface 126 of pressure substrate 120 may be specially treated with optically transparent functional groups so that the conductive material will have a strong bond with the support panel facing surface 126 such that movement of applied conductive material on support panel facing surface 126 will be limited during any deformation of pressure panel 100 under an applied pressure.

Next, in step 620 pressure receiving surface 122 of pressure substrate 120 is coated with an optically transparent material to form a protective coating 124. The optically transparent protective coating 124 applied may comprises a transparent crosslinked polymer resin. The resin can be polymerized from a mixture of mono and multifunctional acrylic monomers and oligomers. The application of the protective coating material can be by slot die coating, gravure coating, Meyer rod coating, or spray coating.

Next, in step 630 optically transparent support panel electrode layer 230 is formed on pressure panel facing surface 222 of optically transparent support substrate 220 from a conductive material. In a preferred exemplary embodiment support electrode 230 is formed in a pattern of straight columns of conductive support layer paths 232 perpendicular in orientation to conductive pressure layer paths 132, with each conductive support layer path 232 comprising a plurality of conductive lines 234 separated by insulating gaps 236 and joined together at path connector end 235. The conductive material may comprise indium-tin-oxide (ITO), indium-zinc-oxide (IZO), indium-tin-zinc-oxide (ITZO), poly(3,4-ethylenedioxythiophene) polystyrene sulfonate (PEDOT:PSS), carbon nanoparticles, carbon nanotubes, graphene, metal nanoparticles, metal nanowires (e.g. silver nanowire (AgNW)), metal nanogrid, metal mesh, conductive polymer nanoparticles, conductive polymer nanoporous network or the mixture thereof. The application of conductive material to pressure panel facing surface 222 may include sputtering, spray coating, screen printing, ink jet printing, laser ablation, stamp printing, photolithography, and so on. The conductive material is then patterned, by way of example, using laser ablation. Where support substrate 220 is glass a middle layer of optically transparent silicon dioxide (SiO2) can first be formed on pressure panel facing surface 222 to help increase the longevity and quality of bonding between the conductive material and support substrate 220.

Next, in step 640 optically transparent spacers 250 are applied on pressure panel facing surface 222 of the support substrate 220. The spacers 250 may be formed of optically clear adhesive (OCA), optically clear resin, or clear photoresist. The spacers 250 may be deposited via screen printing, photolithography, or ink jet printing.

Next, in step 650 optically transparent attachment member 300 is formed along the entire length of outer edge 228 of pressure panel facing surface 222 to create a wall 330 attached at a bottom edge 310 to pressure panel facing surface 222. Attachment member 300 preferably comprises an optically clear adhesive which is screen printed onto pressure panel facing surface 222. Wall 330 of attachment member 300 rises a height 300h above pressure panel facing surface 222 and forms a perimeter boundary for optically transparent insulating space 340 that is located above the pressure panel facing surface 222.

Next, in step 660 an optically transparent insulator 350 is deposited into occupy insulating space 340 above pressure panel facing surface 222, pressure panel electrode layer 230, and spacers 250.

Next, in step 670 optically transparent pressure panel 100 is attached along outer edge 128 of support panel facing surface 126 to upper edge 320 of attachment member 300 such that insulating space 340 and insulator 350 are then located between support panel facing surface 126, wall 330, and pressure panel facing surface 222.

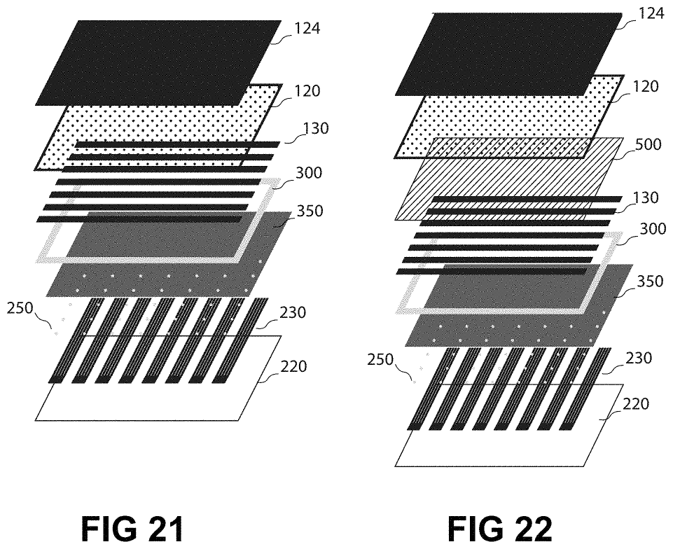

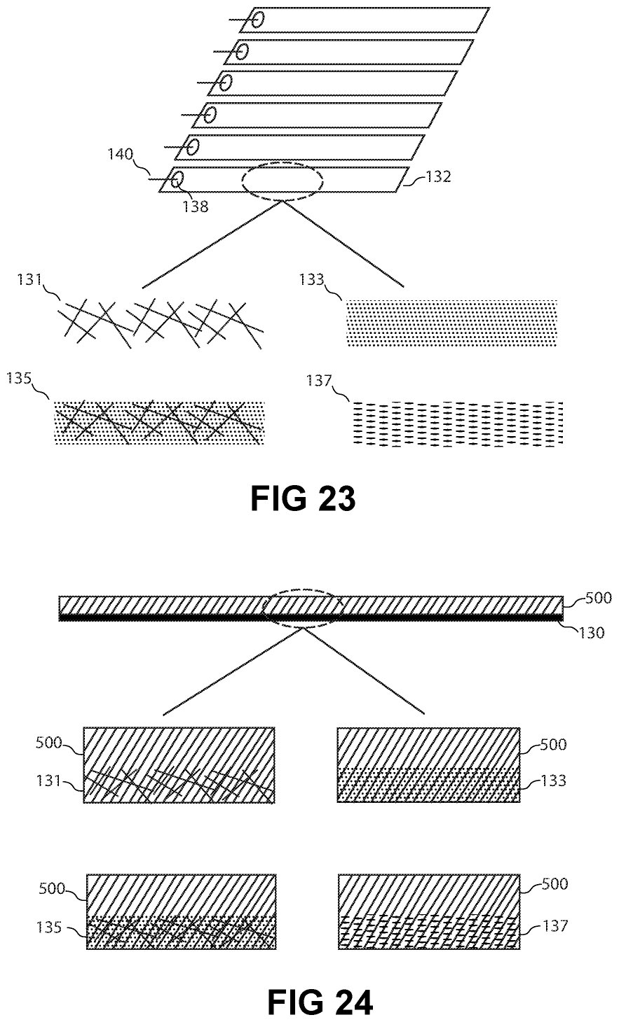

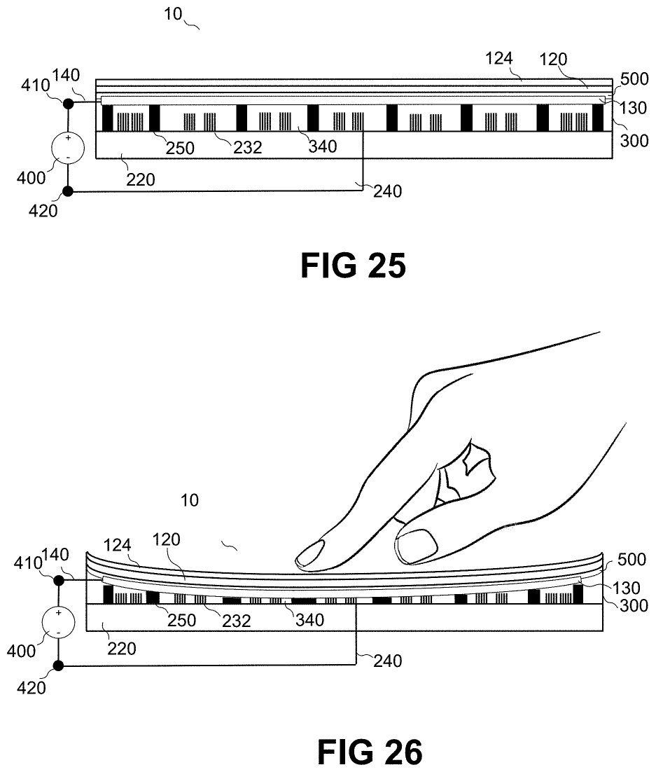

Referring to FIGS. 25-26 a cross-sectional view of the resistive pressure sensor 10 according to a second embodiment is shown. Referring to FIGS. 21-22, there is an additional optically transparent electrode substrate 500 that is on the support panel facing surface 126 of optically transparent pressure substrate 120. Electrode substrate 500 can help protect optically transparent pressure panel electrode layer 130 during deformation (i.e. flexing) under an applied pressure. Electrode substrate 500 may by way of example be formed of silicone, polyurethane, or an acrylic based polymer. Referring to FIG. 24 the pressure electrode 130 is contemplated in a preferred exemplary embodiment to be partially embedded in electrode substrate 500.

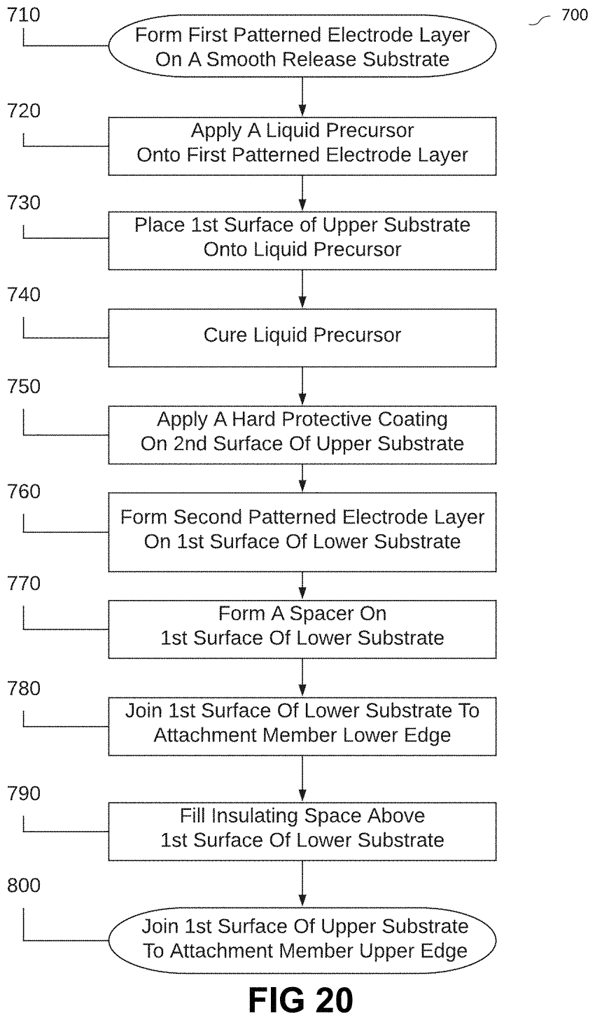

Referring to FIG. 20 the process 700 of fabricating a second embodiment of the resistive pressure sensor device of the present invention is shown.

The process starts with step 710 of forming an optically transparent pressure panel electrode layer 130 comprising a conductive material (e.g. nanoparticles) on a smooth releasing substrate, which may by way of example and not limitation be glass, PET, or any sheet with a smooth surface. The smooth release substrate surface used may also be treated with a release layer, such as a hydrophobic layer. The conductive material may comprise indium-tin-oxide (ITO), indium-zinc-oxide (IZO), indium-tin-zinc-oxide (ITZO), poly(3,4-ethylenedioxythiophene) polystyrene sulfonate (PEDOT:PSS), carbon nanoparticles, carbon nanotubes, graphene, metal nanoparticles, metal nanowires (e.g. silver nanowire (AgNW)), metal nanogrid, metal mesh, conductive polymer nanoparticles, conductive polymer nanoporous network or the mixture thereof. The conductive material can be deposited via spray coating, screen printing, ink jet printing, laser ablation, stamp printing, and so on.

Next, in step 720 a liquid precursor of electrode substrate 500 is deposited on an exposed top surface of pressure panel electrode layer 130. The liquid precursor may be comprised of a polymer formed from a mixture mono and multifunctional acrylic monomers and oligomers. Due to its liquid state the precursor will occupy any gaps in the conductive material of pressure panel electrode layer 130.

Next, in step 730 support panel facing surface 126 of pressure substrate 120 is placed onto the liquid precursor. Next, in step 740 the liquid precursor is cured (e.g. by UV exposure or thermal treatment) to attach electrode substrate 500 to support panel facing surface 126 and pressure panel electrode layer 130. Referring to FIG. 24 the pressure panel electrode layer 130 is contemplated to be at least partially embedded in the cured electrode substrate 500: This helps limit the physical movement the conductive material that makes up pressure panel electrode layer 130 during a deformation (i.e. flexing) under an applied pressure. The smooth releasing substrate beneath electrode substrate 500 is removed after the electrode substrate 500 has cured.

Next, in step 750 pressure receiving surface 122 of pressure substrate 120 is coated with an optically transparent protective material to form protective coating 124. The optically transparent protective coating 124 applied may comprises a transparent crosslinked polymer resin. The resin can be polymerized from a mixture of mono and multifunctional acrylic monomers and oligomers. The application of the protective material can be slot die coating, gravure coating, Meyer rod coating, or spray coating.

Next in step 760 the optically transparent support panel electrode layer 230 is formed on pressure panel facing surface 222 of support substrate 220 in a pattern of columns of conductive support layer paths 232 comprised of conductive lines 234 joined together at path connector end 235. The conductive material may comprise indium-tin-oxide (ITO), indium-zinc-oxide (IZO), indium-tin-zinc-oxide (ITZO), poly(3,4-ethylenedioxythiophene) polystyrene sulfonate (PEDOT:PSS), carbon nanoparticles, carbon nanotubes, graphene, metal nanoparticles, metal nanowires (e.g. silver nanowire (AgNW)), metal nanogrid, metal mesh, conductive polymer nanoparticles, conductive polymer nanoporous network or the mixture thereof. The formation may be by deposition that could include spray coating, screen printing, ink jet printing, laser ablation, stamp printing, photolithography, and so on.

Next, in step 770 optically transparent spacers 250 are formed on top of pressure panel facing surface 222 and/or portions of support panel electrode layer 230. The spacers 250 may be formed of optically clear adhesive (OCA), optically clear resin, or clear photoresist and are deposited via screen printing, photolithography, or ink jet printing.

Next, in step 780 optically transparent attachment member 300 is formed along the entire length of outer edge 228 of pressure panel facing surface 222 to create a wall 330 attached at a bottom edge 310 to pressure panel facing surface 222. Attachment member 300 preferably comprises an optically clear adhesive which is screen printed onto pressure panel facing surface 222. Wall 330 of attachment member 300 rises a height 300h above pressure panel facing surface 222 and forms a perimeter boundary for an optically transparent insulating space 340 that is located above pressure panel facing surface 222.

Next, in step 790 an optically transparent insulator 350 may be deposited into insulating space 340 above pressure panel facing surface 222, support panel electrode layer 230, and spacers 250 so as to occupy insulating space 340.

Next, in step 800 electrode substrate 500 is attached to upper edge 320 of attachment member 300 such that insulating space 340 and insulator 350 are located between electrode substrate 500, wall 330, and pressure panel facing surface 222. In some embodiments where electrode substrate 500 does not fully cover support panel facing surface 126 upper edge 320 will be attached to support panel facing surface 126.

In a third preferred multi-touch embodiment the resistive pressure sensor device of the present invention the pressure panel electrode layer and the support panel electrode layer are configured to also act as an X-Y matrix resistive sensing device that, when incorporated into an electronic system having an appropriately programmed resistive touchscreen controller or equivalent drive and processing circuitry, can detect on the touch surface plane of the resistive pressure sensor device the location in two dimensions and magnitude of an applied force.

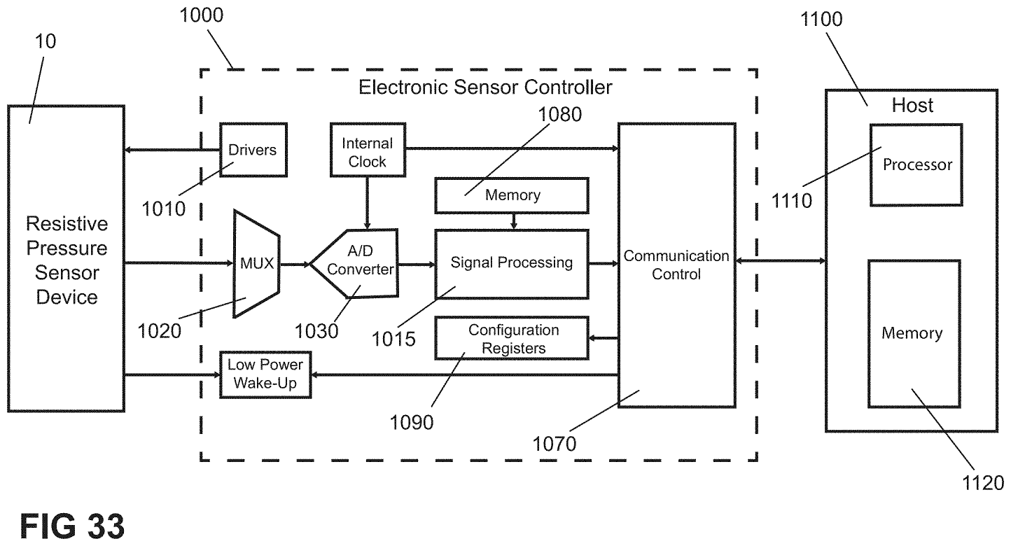

As illustrated in FIGS. 30-31, by way of example and not limitation, in an electronic system incorporating resistive pressure sensor 10 in an x-y-z sensor configuration the pressure panel electrode layer comprises a plurality of conductive pressure layer paths 132i and insulating gaps 133 that are arranged along an X-axis, where 132i designates a specific conductive pressure layer path “i” out of the total set of conductive pressure layer paths. By way of the illustrated example of FIG. 30 there are four conductive pressure layer paths 132₁, 132₂, 132₃ and 132₄. The support panel electrode layer 230 comprises a plurality of conductive support layer paths 232j and lines 234 that are arranged along a Y-axis, where 232j designates a specific conductive support layer path “j” out of the total set of conductive support layer paths. By way of the illustrated example of FIG. 30 there are four conductive support layer paths 232₁, 232₂, 232₃ and 232₄. As shown in FIG. 31 each location that a conductive pressure layer path 132i crosses over a conductive support layer paths 232j constitutes a pixel region 900i,j having a unique x-y coordinate value (e.g. (Xi,Yj) in the plane of pressure substrate 120. Accordingly, the plane of pressure substrate 120 is divided into a plurality of pixel regions 900i,j. If a sufficient force is applied to a pixel region 900i,j of the pressure substrate 120, then a closed circuit will be created from a conductive pressure layer path 132i being moved into electrical contact with a conductive support layer path 232j to form an active pixel 900i,j. Referring to FIG. 33 there is shown an embodiment of a system incorporating the resistive pressure sensor device 10 of FIGS. 30-31 and a connected electronic sensor controller 1000 and host 1100. Host 1100 may be, by way of example and not limitation, a handheld electronic device (e.g. a tablet or smartphone), a laptop computer, a desktop computer, or a computer server. By way of example and not limitation electronic sensor controller 1000 may be similar to the Microchip AR1100 resistive USB and RS232 touch screen controller, and host 1100 may be a general computing device (e.g. a personal computer, tablet, smart phone) having a CPU processor 1110 and computer-readable storage medium 1120. A computer-readable storage medium is any medium capable of storing data, such as operating instructions, that are readable by an electronic or mechanical device, such as a processor, and includes but is not limited to magnetic media, optical media, and printed media. By way of example and not limitation a computer-readable storage medium may be an EEPROM, ROM, flash memory, RAM, a hard disk, or optical disk.

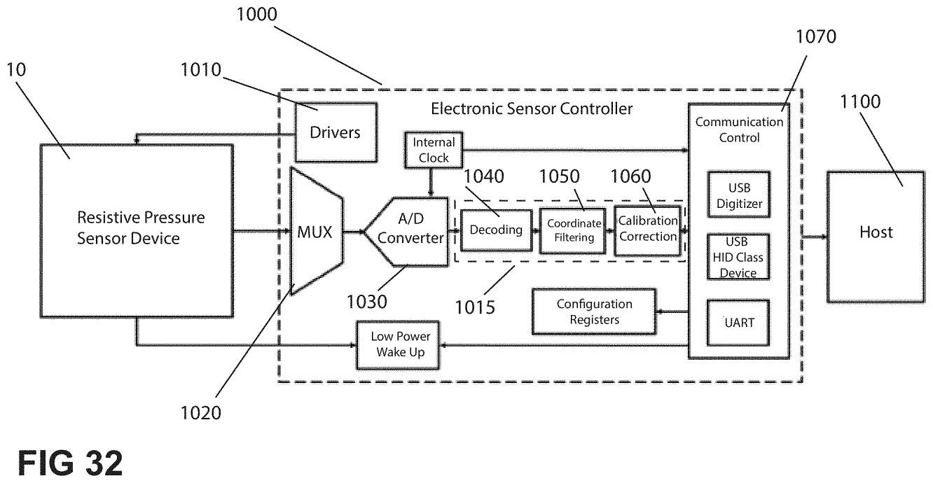

Electronic sensor controller 1000 is comprised of drive circuitry 1010, multiplexer 1020, analog-to-digital (i.e. “A/D”) converter 1030, signal processing module 1015, computer-readable storage memory 1080 (e.g. a flash memory), configuration registers 1090, and communication control module 1070. Referring to FIG. 32 in an exemplary signal processing module 1015 there is a decoding module 1040; coordinate filtering module 1050, and calibration correction module 1060. It is contemplated in a preferred embodiment that host 1100 and electronic sensor controller 1000 would be combined together into the housing of single device such as a handheld electronic device.

In operation of the system of FIG. 33 incorporating the embodiment of resistive pressure sensor device 10 of as shown in FIGS. 30-31 it an electrical signal is applied by drive circuitry 1010 sequentially to each individual x-axis conductive pressure layer paths 132i. Each time an electrical signal is applied to a conductive pressure layer path 132i each y-axis conductive support layer path 232j that is crossing the x-axis conductive pressure layer path 132i is sampled (i.e. measured) by the multiplexer 1020 of electronic sensor controller 1000 to detect the activation of any pixels 900i,j as a result of physical contact made between the x-axis conductive pressure layer path 132i and the sampled y-axis conductive support layer path 232j from a force applied to the pressure receiving surface 122 along the orthogonal z-axis of pressure panel 100.

If an electrical signal is detected from a sampled intersection of pixel 900i,j, then sampled intersection 900i,j is an active pixel and electronic sensor controller 1100 generates from the output of A/D converter 1030 in accordance with at least one operating instruction (e.g. firmware) stored in a computer-readable storage medium 1080 of the electronic sensor controller 1000 x-y coordinate data representing the x-y coordinate location on the pressure receiving surface 122 for the active pixel 900i,j and pressure data representing a measure of the force applied to the pressure receiving surface along a z-axis orthogonal to the x-y coordinate plane at active pixel 900i,j. The pressure data representing the measure of applied force along the z-axis is determined from the measured amplitude of the detected electrical signal received by multiplexer 1020 from active pixel 900i,j in accordance with at least one operating instruction stored in a computer-readable storage medium 1080 of the electronic sensor controller 1000.

The amplitude of an electrical signal conducted through active pixel 900i,j will depend upon the electrical resistance of active pixel 900i,j, which is dependent on the area of physical contact made between conductive pressure layer path 132i and the discrete conductive lines 234 of conductive support layer path 232j: This will be dependent on the amount of pressure applied to pressure receiving surface 122 of pressure panel 120 along an orthogonal z-axis at the location of active pixel 900i,j.

Accordingly, data representing a two-dimensional location (x,y) on the x-y coordinate plane of pressure substrate 120 where a force is applied is determined in conjunction with a measure of the applied pressure at the x-y coordinate along the orthogonal z-axis. Thus, a three-dimensional measurement (x,y,z) for a force applied to the resistive pressure sensing device 10 is obtained. The x-y coordinate data and pressure data are transmitted in a touch report generated and communicated by electronic sensor controller 1000 to host 1100.

Such an exemplary embodiment can be used as an electronic multi-touch system to detect a precise location of a single touch, a multitouch, and different gestures while simultaneously measuring the magnitude of the force applied at distinct points across the pressure receiving surface. When plural objects are pressed against the pressure receiving surface of the multi-touch resistive pressure sensor device embodiment, one or more active pixels 900i,j are formed for each touch point. Each active pixel 900i,j associated with a location of applied force will conduct a location signal from which the electronic controller 1100 can determine the position (i.e. the x-y coordinate) on the plane of pressure substrate 120 where a force is applied, with the amplitude of the location signal being used to measure the resistance at 900i,j to determine the amplitude of force (i.e. depth) applied on the touch point along the orthogonal z-axis.

By analyzing the number of active pixels 900i,j and their distribution, an electronic system incorporating the resistive pressure sensor device is able to detect different gestures. By way of example, a narrow-tipped stylus may create just a single active pixel, while a broad-tipped human finger may create three to five active pixels 900 that form a round shape. A two-finger press gesture may create six to eight active pixels 900 forming an elliptical shape. A two-finger pinch gesture will create two groups of active pixels 900 that form two closely patterned round shapes. The two round shapes may be slightly smaller than a finger pressing, but larger than a stylus pressing. Simultaneously, each of the active pixels 900 is able to measure the applied force of each touch event.

Multi-touch events sensed using a multi-touch system incorporating the pressure sensor invention can be used separately or together to perform singular or multiple actions. When used separately, a first touch event may be used to perform a first action while a second touch event may be used to perform a second action that is different than the first action. The actions may for example include moving an object such as a cursor or pointer, scrolling or panning, opening a file or document, making a selection, etc. When used together, first and second touch events may be used for performing one complex action. The complex action may for example include permitting access to a restricted area, logging out the account and exit, loading a user's customized setting, etc.

While particular embodiments and applications of the present resistive pressure sensor device and systems using it have been shown and described changes and modifications may be made, and the appended claims are to encompass within their scope all such changes and modifications as are within the true spirit and scope of the invention.

1. A system for measuring pressure at an x-y coordinate in an x-y coordinate plane of a pressure receiving surface, the system being comprised of:
(a) a resistive pressure sensing device and an electronic sensor controller;
(b) the resistive pressure sensing device comprised of;
(1) a support panel adjacent and parallel to the flexible pressure panel;
(2) the flexible pressure panel having a support panel facing surface that is opposite and parallel to the pressure receiving surface of the flexible pressure panel;
(3) a pressure panel electrode layer attached to the support panel facing surface of the flexible pressure panel, where the pressure panel electrode layer is comprised of at least one conductive pressure layer path having an electronic connection to the electronic sensor controller;
(4) a support panel electrode layer attached to a flexible pressure panel facing surface of the support panel, where the support panel electrode layer is comprised of at least one conductive support layer path having an electronic connection to the electronic sensor controller;
(5) either the at least one conductive pressure layer path or the at least one conductive support layer path having a plurality of discrete conductive lines electrically joined at a path connector end;
(6) an angle of intersection between the at least one conductive pressure layer path and the at least one conductive support layer path in the x-y coordinate plane; and
(7) an insulating space located between the pressure panel electrode layer and the support panel electrode layer; and
(c) at least one operating instruction stored in a computer-readable storage medium of the electronic sensor controller for determining, from a change in a measured amplitude of an electrical signal conducted through a sampled intersection of a conductive support layer path and a conductive pressure layer path, a change in the amount of force applied to the pressure receiving surface at the x-y coordinate of the sampled intersection.

2. The system of claim 1 where the at least one operating instruction is instead stored in a computer-readable storage medium of a host with an electronic connection to the electronic sensor controller.

3. The system of claim 1 where the angle of intersection between the conductive pressure layer path and the conductive support layer path is orthogonal.

4. The system of claim 1 where the at least one conductive pressure layer path and the at least one conductive support layer path both have a plurality of discrete conductive lines electrically joined at a path connector end.

5. The system of claim 1 further comprising a spacer between the support panel facing surface and the pressure panel facing surface.

6. The system of claim 1 where the flexible pressure panel is joined to the support panel through an attachment member.

7. The system of claim 6 where the attachment member is attached on a lower edge to an outer edge of the flexible pressure panel facing surface of the support panel and attached on an upper edge to an outer edge of the support panel facing surface of the flexible pressure panel.

8. The system of claim 1 where the resistive pressure sensing device is optically transparent.

9. The system of claim 1 further comprising a protective coating on the pressure receiving surface of the flexible pressure panel.

10. The system of claim 1 further comprising a flexible electrode substrate attaching the pressure panel electrode layer to the support panel facing surface.
